(19) United States
(12) Patent Application Publication
(10) Pub. No.: US 2024/0135254 A1
(43) Pub. Date: Apr. 25, 2024

(54) PERFORMING CLASSIFICATION TASKS USING POST-HOC ESTIMATORS FOR EXPERT DEFERRAL

(71) Applicant: Google LLC, Mountain View, CA (US)

(72) Inventors: Harikrishna Narasimhan, Sunnyvale, CA (US); Wittawat Jitkrittum, Atlanta, GA (US); Aditya Krishna Menon, New York, NY (US); Ankit Singh Rawat, New York, NY (US); Sanjiv Kumar, Jericho, NY (US)

(21) Appl. No.: 18/488,951

(22) Filed: Oct. 17, 2023

Related U.S. Application Data
(60) Provisional application No. 63/416,855, filed on Oct. 17, 2022.

(51) Int. Cl. G06N 20/00; G06N 5/04

(52) U.S. Cl. CPC G06N 20/00; G06N 5/04

(57) ABSTRACT

Methods, systems, and apparatus, including computer programs encoded on computer storage media, for post-hoc deferral for classification tasks. In particular, a system can perform either post-hoc threshold correction or post-hoc rejector training to account for the cost of deferring model inputs to an expert system for classification.

### CROSS-REFERENCE TO RELATED APPLICATION

This application claims priority to U.S. Provisional Application No. 63/416,855, filed on Oct. 17, 2022. The disclosure of the prior application is considered part of and is incorporated by reference in the disclosure of this application.

### BACKGROUND

This specification relates to classifying inputs using a machine learning model.

One example of a machine learning model is a neural network. Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that performs a classification task on a new model input using a classifier machine learning model and one or more expert systems.

In particular, when the system receives a new model input, the system determines whether to (i) classify the new model input using the model output of the classifier machine learning model or to (ii) defer the new model input for processing by one of the expert systems.

Particular embodiments of the subject matter described in this specification can be implemented so as to realize one or more of the following advantages.

Many real-world settings allow a classifier to defer predictions to one or more costly expert systems. For example, the learning to defer paradigm allows a classifier to defer to an expert system that makes use of a human expert, at the cost of additional latency in providing the output and, in some cases, at some monetary cost. Similarly, the adaptive inference paradigm allows a base model to defer to one or more large models, at some computational cost.

The goal in these settings is to learn classification and deferral mechanisms to optimize a suitable accuracy-cost tradeoff. To achieve this, some approaches attempt to design a coherent loss function for both mechanisms. However, these existing losses can underfit the training set when there is a non-trivial deferral cost of deferring to the expert system, resulting in an inefficient mechanism for determining which model inputs to defer after training. That is, these approaches are unable to accurately account for the deferral cost and therefore do not accurately estimate the actual accuracy-cost tradeoff after training.

To resolve this, this specification describes two post-hoc estimators that fit a deferral function on top of a base classifier model, either by threshold correction, or by learning when the base model's error rate exceeds the cost of deferring to the expert. Both approaches yield effective accuracy-cost tradeoffs on learning to defer and adaptive inference benchmarks, i.e., both approaches outperform prior techniques in effectively making use of the expert system to improve overall accuracy while minimizing costs incurred after training.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example classifier system.

FIG. 2 is a flow diagram of an example process for generating a classification using post-hoc threshold correction.

FIG. 3 shows the operation of the system when using post-hoc threshold correction.

FIG. 4 is a flow diagram of an example process for generating a classification using post-hoc rejection function training.

FIG. 5 shows the operation of the system when using post-hoc rejection function training.

Like reference numbers and designations in the various drawings indicate like elements.

### DETAILED DESCRIPTION

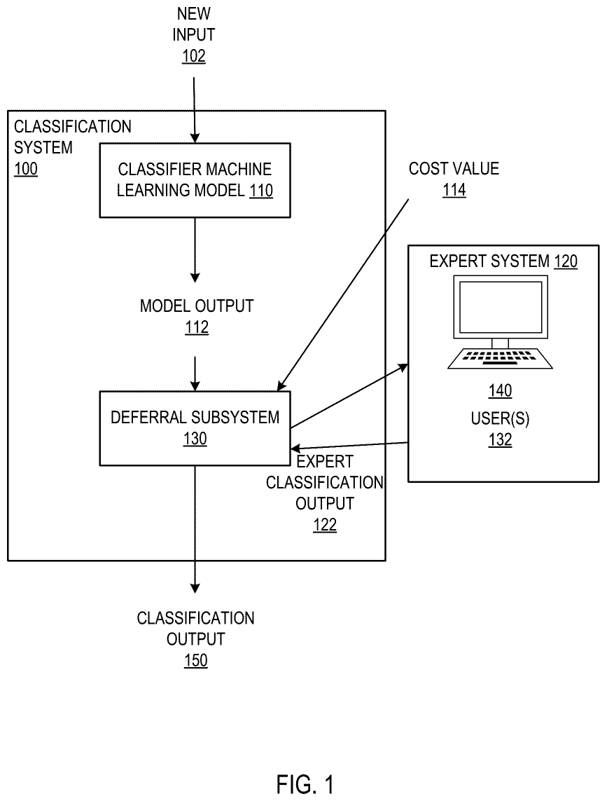

FIG. 1 shows an example classifier system 100.

The system 100 is an example of a system implemented as computer programs on one or more computers in one or more locations, in which the systems, components, and techniques described below can be implemented.

The system 100 performs a classification task on new model inputs 102 using a classifier machine learning model 110 and one or more expert systems 120.

At a high level, the system 100 receives a cost value 114, e.g., from a user that also provides the new model inputs 102, from a different user, or from another system that automatically computes the cost value 114.

When the system 100 receives a new model input 102, a deferral subsystem 130 within the system 100 makes use of the cost value 114 and a model output 112 of the classifier machine learning model 110 generated by processing the new model input 102 to determine whether to (i) classify the new model input 102 using the model output 112 of the classifier machine learning model or to (i) defer the new model input 102 for processing by one of the expert systems 120.

Generally, in this specification, “deferring” a new model input 102 refers to using one of the expert systems 120 to generate a system classification output 150 for the new model input 120 rather than using the model output 112 generated by the classifier machine learning model 110.

Thus, in response to determining to defer the new model input 102, the subsystem 130 provides the new model input 102 for processing by the expert system 120 and obtains, from the expert system 102, an expert classification output 122 for the new model input 102.

The subsystem 130 then provides, as the system classification output 150 for the new model input 102, the expert classification output 122.

In response to determining not to defer the new model input 102, the subsystem 130 generates a classification output using the model output 112 and then provides, as the system classification output 150, the classification output.

The cost value 114 represents a cost associated with deferring model inputs to the expert system 120.

The cost value 114 can represent any of one or more of a variety of “costs” that are incurred when the expert system 120 is required to be used for a given model input, i.e., costs that would not be incurred if the expert system 120 did not need to be used and only the model output 112 was used to classify the given model input.

For example, the cost value 114 can represent the expected additional latency required to generate a system output if the model input is deferred to the expert system 120.

As another example, the cost value 114 can represent the expected additional computational cost required to generate a model output if the model input is deferred to the expert system 120, e.g., the additional memory consumed, processor cycles required, network bandwidth consumed, and so on.

As yet another example, the cost value 114 can represent the expected additional monetary cost that is required to generate a model output if the model input is deferred to the expert system 120.

It should be understood that the cost value 114 represents a fixed cost that is independent of the model input 102 and that is separate from the “cost” resulting from the likelihood that the expert system 120 misclassifies the model input. That is, the cost value 114 represents a cost that is incurred independent of whether making use of the expert system 120 results in a classification that is more accurate than the model output generated by the classifier machine learning model 110.

When the cost value 114 represents multiple different costs, the cost value can be a combination of, e.g., a sum or an average, of individual cost values that are associated with each of the multiple different costs.

The one or more expert systems 120 can be any of a variety of systems that generate classification outputs and that, for at least some model inputs, can generate a classification output that is more accurate than one generated by the classification model 110. Generally, making use of an expert system 120 incurs additional cost(s) relative to using only the classification model 110, as described above.

As one example, the expert systems 120 can include a system that provides the model input or a representation of the model input for presentation to a human user 132, e.g., on a user device, 140 and allows the user 132 to submit an input that classifies the model input. The user's classification is then used as the expert classification output 122. In this example, the use of the expert system 120 can incur a variety of costs, including increased latency, increased consumption of resources, e.g., network bandwidth and processor cycles, and, potentially, monetary cost.

As another example, the expert systems 120 can include another classifier machine learning model that is more computationally expensive than the classifier machine learning model 110. For example, the other model can have one or more of the following properties that cause the model to be more computationally expensive: the other model can have more parameters, the other model can have more layers, the other model can operate on higher-resolution versions of model inputs, the other model can be implemented on higher-precision hardware is more computationally expensive to use, and so on.

In some implementations, the system 100 can include a “cascade” or “hierarchy” that includes a respective classifier model at each of multiple levels. The model at any given level is more computationally expensive than the model at the preceding layer, e.g., for one of the reasons described above. Optionally, the model at any given level after the first level can receive as input not only the model input but also the model output generated by the model at the preceding level.

In these implementations, at each level, the model at the current level is the “classifier model” 110 described above while the models at all higher levels collectively serve as the “expert.” Thus, the system 100 uses the described techniques to determine, at each level, whether to defer to the next level or to use the output from the current level to classify the model input.

In other words, the system 100 can iteratively traverse the cascade, starting at the lowest level. At each iteration, the system 100 treats the model at the current level for the iteration as the classifier model 110 and determines whether to classify the model input using the current model or to defer to the expert system, i.e., to the model(s) at the higher level(s). If the system 100 determines to classify the model input using the current model, the system can stop traversing the cascade and generate the final system output 130. If the system 100 determines to defer, the system can repeat the process for the next level. If the system 100 reaches the highest level of the cascade, the system 100 classifies the model input using the model at the highest level, i.e., without making a determination regarding whether to defer.

The system 100 can be configured to perform any of a variety of classification tasks. As used in this specification, a classification task is any task that that requires the system to generate an output that includes a respective score for each of a set of multiple categories and to then select one or more of the categories as a “classification” for the model input using the respective scores, i.e., by selecting the one or more highest-scoring categories. That is, the classification output generated from the model output and the expert classification output can each identify one or more selected categories and, optionally, the scores for the selected categories.

One example of a classification task is image classification, where the model input is an image, e.g., the intensity values of the pixels or the voxels of the image, the categories are object categories, and the task is to classify the image as depicting an object from one or more of the object categories. That is, the classification output for a given input image is a prediction of one or more object categories that are depicted in the input image.

For example, the image can be a medical image generated by a medical imaging device; as particular examples, the image can be a computer tomography (CT) image, a magnetic resonance imaging (MRI) image, an ultrasound image, an X-ray image, a mammogram image, a fluoroscopy image, a fundus image, or a positron-emission tomography (PET) image, or an image of a patient's body that is an RGB image generated by a camera sensor, e.g., of a mobile device or a digital camera.

In some of these examples, the object categories can indicate whether the corresponding patient that is depicted in the image has a particular property. That is, the object categories can each correspond to different values of the particular property for the object (patient) depicted in the image.

For example, the object categories can indicate whether the patient has a particular medical condition, e.g., a particular type of cancer, e.g., breast cancer or lung cancer, hypertension, macular degeneration, diabetes, a skin condition, and so on.

As another example, the object categories can indicate whether the patient is at risk for suffering an adverse health event, e.g., a heart attack, a stroke, or an adverse kidney injury.

As another example, the image can be an image of an object manufactured at a manufacturing facility, e.g., an assembly line or other facility, and the object categories can indicate whether the object has a specified type of defect.

Another example of a classification task is text classification, where the model input is text and the task is to classify the text as belonging to one multiple categories. One example of such a task is sentiment analysis task, where the categories each correspond to different possible sentiments of the task. Another example of such a task is a reading comprehension task, where the input text includes a context passage and a question and the categories each correspond to different segments from the context passage that might be an answer to the question. Other examples of text processing tasks that can be framed as classification tasks include an entailment task, a paraphrase task, a textual similarity task, a sentiment task, a sentence completion task, a grammaticality task, and so on.

Other examples of classification tasks include audio classification tasks, where the model input is audio data. Some examples of such tasks include speech classification tasks, where the model input is audio representing speech. Examples of speech processing tasks include language identification (where the categories are different possible languages for the speech), hotword identification (where the categories indicate whether one or more specific “hotwords” are spoken in the audio data), and so on.

As another example, the task can be a health prediction task, where the input is a sequence derived from electronic health record data for a patient and the categories are respective predictions that are relevant to the future health of the patient, e.g., a predicted treatment that should be prescribed to the patient, the likelihood that an adverse health event will occur to the patient, predictions related to the presence or absence (or the severity) of a given medical condition, or a predicted diagnosis for the patient.

The classifier model 110 can be any appropriate machine learning model that maps a model input of the type required by the classification task, e.g., an image, a sequence of text, an audio signal, and so on, to a set of logits. A “logit” as used in this specification generally refers to a score, i.e., a numerical value.

The set of logits includes a respective classification logit score fₗ for each category of the L categories for the classification task and a deferral logit score f_{⊥} for a “deferral” category that represents deferring to the expert system 120.

For example, the classifier machine learning model 110 can be configured to process the model input x to generate a shared embedding ϕ(x) of the model input.

The model 110 can then, for each classification category l, apply a respective set of logit weights wₗ for the classification category to the shared embedding to generate the classification logit for the classification category, i.e., so that fₗ=wₗ^{T}ϕ(x), and apply a set of deferral logit weights w_{⊥} to the shared embedding to generate the deferral logit, i.e., so that f_{⊥}=w_{⊥}^{T}ϕ(x).

Examples of appropriate machine learning models include neural networks, e.g., self-attention neural networks, convolutional neural networks, fully-connected neural networks, recurrent neural networks, and so on, random forest models, gradient boosted tree models, support vector machines, and so on.

In some cases, the model 110 then maps the logits to a respective probability for each of the categories, e.g., by processing the logits through a softmax layer.

Generally, the subsystem 130 can use one of two approaches to determine whether to defer a given model input to a speaker.

Both approaches are “post-hoc” approaches. A “post-hoc” approach, as used in this specification, is one that is taken after the classifier model 110 has already been trained.

That is, the system 100 or another training system first trains the classifier model 110 to perform the classification task on training data for the classification task. For example, the system 100 can first train the classifier model 110 to minimize a loss function that measures a performance of classification outputs generated based on model outputs generated by the classifier machine learning model.

As a particular example, the loss function can be one that assumes that the deferral cost 114 is zero and trains to maximize accuracy given the ability of the system 100 to defer to the expert system 120 if needed.

The system 100 then makes a “post-hoc,” post-training, adjustment to account for the actual cost value 114.

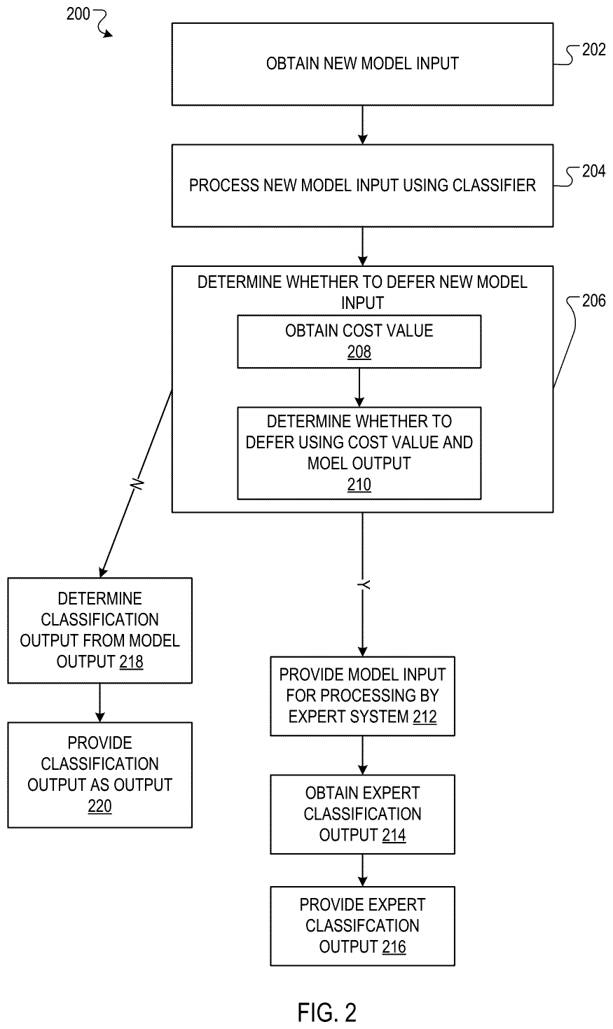

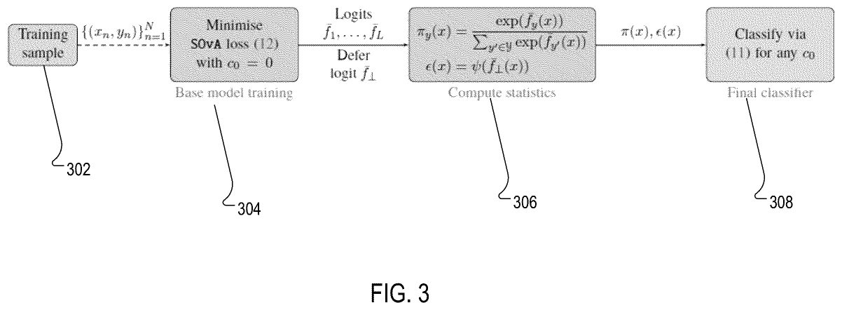

One such approach is referred to as “post-hoc threshold correction” and is described below with reference to FIGS. 2 and 3.

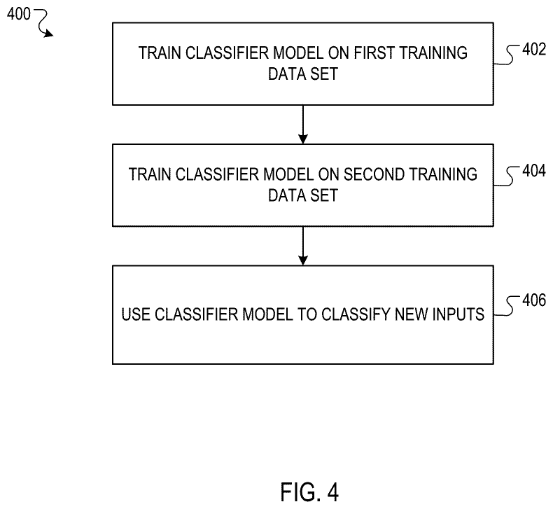

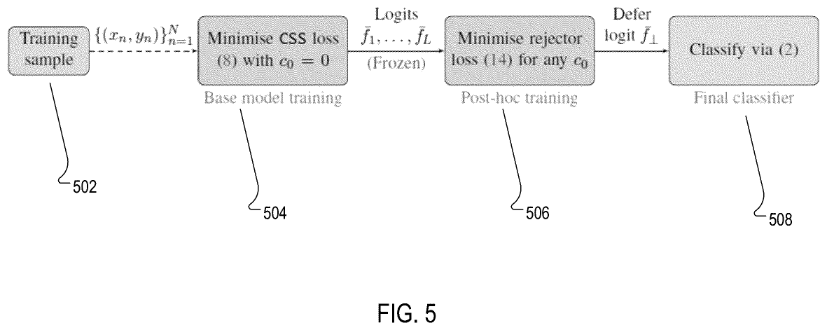

Another such approach is referred to as “post-hoc rejector training” and is described below with reference to FIGS. 4 and 5.

FIG. 2 is a flow diagram of an example process 200 for generating a classification using post-hoc threshold correction. For convenience, the process 200 will be described as being performed by a system of one or more computers located in one or more locations. For example, a classifier system, e.g., the classifier system 100 of FIG. 1, appropriately programmed in accordance with this specification, can perform the process 200.

The system obtains a new model input (step 202).

The system processes the new model input using a classifier machine learning model to generate a model output (step 204).

The model output includes (i) a respective classification probability πₗ for each of the classification categories for the classification task, and (ii) a misclassification probability ε that represents a likelihood that the new model input will be misclassified by an expert system that is different from the classifier machine learning model.

As described above, the set of logits generated by the model includes a respective score for each of the classification categories.

The set of logits also includes a deferral logit score.

That is, the classifier machine learning model processes the new model input to generate (i) a respective classification logit score for each of the plurality of classification categories and (ii) a deferral logit score.

The system then generates the model output by applying a softmax function to the classification logit scores to generate the respective classification probabilities and by applying an inverse link function ψ to the deferral logit score f_{⊥} to generate the misclassification probability, i.e., so that ε=ψ(f_{⊥}). The inverse link function can be, e.g., a sigmoid function.

That is, the system uses the inverse link function to map the deferral logit to a misclassification probability.

The system then determines, from the model output, whether to defer the new model input for processing by the expert system (step 206).

In particular, in order to determine whether to defer the new model input, the system obtains a cost value c₀ that represents a cost associated with deferring model inputs to the expert system (step 208) and determines whether to defer the new model input based on the cost value and the model output (step 210).

In particular, the system can determine to defer the new model input only when one minus the highest probability among the classification probabilities is greater than or equal to the sum of (i) the cost value c₀ and (ii) the misclassification probability ε. In other words, the system defers when 1−max_{y}π_{y}(x)≥c₀+ε(x), where y ranges across all of the categories l in the set of categories.

Thus, the system uses the cost value and the misclassification probability to determine a “post-hoc” threshold that governs whether the model input will be deferred to the expert system or not. More specifically, the system uses the cost value to “correct” the misclassification probability when determining the post-hoc threshold.

In response to determining to defer the new model input, the system provides the new model input for processing by the expert system (step 212) and obtains, from the expert system, an expert classification output for the new model input (step 214). The system then provides, as output, the expert classification output (step 216).

In in response to determining not to defer the new model input, the system determines a classification output from the respective classification probabilities for each of the plurality of classification categories (step 218) and provides, as output, the classification output (step 220).

FIG. 3 shows an example 300 of the operation of the classifier system 100 when using the post-hoc threshold correction approach.

As shown in the example of the FIG. 3, the system first trains 304 the classifier machine learning model 110 through base model training on a set of training samples 302 that each include a training model input and a ground truth classification output for the training model input.

The training 304 is referred to as “base” model training because the system trains the classifier model 110 using a base loss function that assumes that the cost value is zero.

For example, the system can train the classifier model 110 on a loss function on a hybrid loss function (S0vA) that estimates ground truth classification outputs using a cross-entropy loss and ground truth expert misclassification probabilities using a learning to defer loss.

For example, the learning to defer loss may be a one-versus-all (OvA) loss.

As a particular example, the hybrid loss function can satisfy:

l_{SOvA}(x,y,f(x))=−log π_{y}(x)+(cₘₐₓ−cₑₓₚ(x,y))·φ(f_{⊥}(x)))+cₑₓₚ(x,y)φ(−f_{⊥}(x))),

where x is a model input, y is the ground truth model output for the model input, f(x) is the set of logit scores for the model input x that includes the classification logit scores fₗ(x) and the deferral logit score f_{⊥}(x)), π_{y}(x) is the classification probability for the ground truth output y, φ is a proper composite loss, cₘₐₓ is an estimate of a maximum possible deferral cost, and cₑₓₚ(x, y) is the actual cost of deferring the model input x.

For example, cₑₓₚ(x, y) can be a constant and can be equal to c₀. As another example, cₑₓₚ(x, y) can be equal to c₀ if the expert correctly classifies x and equal to c₀+1 if the expert incorrectly classifies x. Thus, cₘₐₓ can be equal to 1 or c₀+1.

However, as described above, the system can perform this base training with the cost value, i.e., c₀, set to zero. Thus, for the base training, cₑₓₚ(x, y) can be a constant and can be equal to zero. As another example, cₑₓₚ(x, y) can be equal to 0 if the expert correctly classifies x and equal to 1 if the expert incorrectly classifies x. Accordingly, cₘₐₓ can be equal to 1 for the base training.

As a particular example, the proper composite loss that is a binary proper composite loss and can be equal to, e.g., φ(z)=log (1+e^{-z}).

By using the hybrid loss function, the system can account for the fact that training using only cross-entropy may not provide calibrated misclassification probabilities and that training using only the learning to defer loss may result in the classification probabilities underperforming when the number of categories is large.

As a result of this training, the system obtains a model that generates classification logits for the L classification categories and a deferral logit.

The system then defines the computation 306 of the classification and misclassification probabilities by defining the softmax of the classification logits and the inverse link function as described above.

The system can then use the resulting model to classify 308 new inputs. Advantageously, the system can use the resulting model to classify new inputs with any appropriate deferral cost value without needing to re-train the model when a new deferral cost value is identified. That is, after training, the system can use the same model to classify new inputs for multiple different cost values, e.g., if the cost value changes across time.

FIG. 4 is a flow diagram of an example process 400 for training a classifier model using post-hoc deferral function retraining. For convenience, the process 400 will be described as being performed by a system of one or more computers located in one or more locations. For example, a classifier system, e.g., the classifier system 100 of FIG. 1, appropriately programmed in accordance with this specification, can perform the process 400.

The system trains the classifier machine learning model on a first training data set (step 402).

As described above, the classifier model is configured to receive as input a model input and to process the model input to generate a model output that includes (i) a respective classification logit score for each of a plurality of classification categories, and (ii) a deferral logit score.

In particular, the system trains the classifier machine learning model to minimize a loss function that measures a performance of a system that determines, using at least the deferral logit scores, whether to generate classification outputs based on model outputs generated by the classifier machine learning model or based on expert classification outputs generated by an expert system.

Generally, the loss function measures the performance of the system when the cost value is set to zero. Thus, the performance of the system is measured only in terms of classification accuracy and not in terms of costs incurred as a result of determining to defer inputs to the expert system.

For example, the system can train the classifier model using a cost-sensitive softmax cross-entropy (CSS) loss that incorporates the deferral logit into a conventional cross-entropy loss function.

That is, when the deferral cost is zero, the CSS loss can satisfy:

l_{CSS}(x,y,f(x))=−log p_{y}(x)−1(y=hₑₓₚ(x))·log (p_{⊥}(x)),

where 1 (y=hₑₓₚ(x)) is an indicator function that is equal to 1 if y=hₑₓₚ(x) and 0 otherwise, hₑₓₚ(x) is the classification output generated by the expert system for the input x, p_{y}(x) is a probability for the ground truth output y, p_{⊥}(x) is a probability for the deferral logit, and the probabilities are generated by applying a softmax function to the set of logit scores generated for the input x.

After training the classifier machine learning model on the first training data set, the system trains the classifier machine learning model on a second training data set (step 404). The second training data set may be, e.g., all of or part of the first training data set or may be a different fine-tuning data set that has been obtained by the system.

In particular, the system trains the classifier model to minimize a surrogate rejector loss.

As described above, the classifier machine learning model can be configured to process the model input to generate a shared embedding of the model input and then to, for each classification category, apply a respective set of logit weights for the classification category to the shared embedding to generate the classification logit for the classification category and apply a set of deferral logit weights to the shared embedding to generate the deferral logit.

In these cases, to train the classifier on the second training data set, the system can train the deferral logit weights while holding the classification logit weights for the classification categories fixed. The system can also hold fixed the other weights of the classifier model, e.g., the weights used to generate the shared embedding.

Thus, the system holds the classification logits “frozen” while training the model to accurately account for the deferral cost value when generating the deferral logit, which will define whether the model input is deferred to an expert system after training.

For any given model input, the surrogate rejector loss measures an expected loss incurred by deferring the given model input for processing by the expert system given (i) whether the given model input is misclassified by the classifier machine learning model and the expert system and (ii) a cost value that represents a cost associated with deferring model inputs to the expert system.

That is, during this second training and unlike during the first training, the system uses the actual value of the deferral cost that will be used after training, i.e., when performing inference for new inputs, rather than assuming that the deferral cost is zero.

For example, for any given model input, the surrogate rejector loss (i) can based on an output of a rejector function that is applied to a given model output for the given model input and that defines whether the given model input will be deferred to the expert system for processing and (ii) include a) a first term that is based on a non-deferral confidence score for the given model input derived from the output of the rejector function and on whether the given model input is misclassified by the given model output and b) a second term that is based on a deferral confidence score for the given model input derived from the output of the rejector function, the cost value that represents the cost associated with deferring model inputs to the expert system, and, optionally, on whether the given model input is misclassified by the expert system.

As a particular example, the surrogate rejector loss can satisfy:

lᵣₑⱼ(x,y,r(x),h)=c_{mod}(x,y))·φ(r(x))+cₑₓₚ(x,y)·φ(−r(x)),

where r(x) is the rejector function, cₑₓₚ(x, y) depends on the cost c₀, and φ is a proper composite loss.

For example, cₑₓₚ(x, y) can be a constant and can be equal to c₀. As another example, cₑₓₚ(x, y) can be equal to c₀ if the expert correctly classifies x and equal to c₀+1 if the expert incorrectly classifies x.

Similarly, c_{mod}(x, y) can be equal to 0 if the classification model correctly classifies x and equal to 1 if the model incorrectly classifies x.

As a particular example, the proper composite loss can be a binary proper composite loss and can be equal to, e.g., φ(z)=log (1+e^{-z}).

Thus, the deferral confidence score is generated by applying a proper composite loss φ to a negative of the output of the rejector function. Similarly, the non-deferral confidence score can be generated by applying the proper composite loss φ to the output of the rejector function.

For example, the rejector function r(x) can measure a difference between the largest classification logit in the given model output and the deferral logit in the given model output.

For example, the rejection function can satisfy r(x)=f_{⊥}(x)−max_{y}f_{y}(x), where y ranges across all of the classification categories.

As another example, the rejector function r(x) can be based on an input-dependent bias term and probabilities determined from the classification logits in the given model output, the deferral logit in the given model output, or both.

For example, the rejection function can satisfy:

$$r ( x ) = {g}_{⊥} ( x ) + \frac{{p}_{⊥} ( x )}{1 - {p}_{⊥} ( x )} - {max}_{y} \frac{{p}_{y} ( x )}{1 - {p}_{y} ( x )} ,$$

where g_{⊥}(x) is the input-dependent bias term that is learned during the training of step 404.

After training the classifier machine learning model on the second training data set, the system uses the classifier model to perform the classification task (step 406).

In particular, the system can obtain a new model input and process the new model input using the classifier machine learning model to generate a new model output.

They system can then determine, from the new model output, whether to defer the new model input for processing by the expert system. In particular, the system can determine not to defer the new model input only when the largest classification logit in the new model output is larger than the deferral logit in the new model output.

That is, because of the training in step 404, the model output already reflects the cost value and the system can simply compare the largest classification logit to the deferral logit to determine whether to defer the new model input.

In response to determining to defer the new model input, the system provides the new model input for processing by the expert system and obtains, from the expert system, an expert classification output for the new model input. The system then provides, as the system output, the expert classification output.

In response to determining not to defer the new model input, the system determines a classification output from the respective classification logits for each of the plurality of classification categories in the new model output and provides, as the system output, the classification output.

FIG. 5 shows an example 500 of the operation of the system 100 when using the post-hoc deferral function re-training.

As shown in FIG. 5, the system performs base training 504 on the first training data set that includes multiple training samples 502. As described above, the system sets the deferral cost value equal to 0 for this base training 504.

After this training, the system keeps the portion of the model 110 that generates the classification logits for the L classification categories frozen.

The system then further trains 506 the model 110 by minimizing the rejector loss described above for the actual value of the cost. As a result of this training, the system updates the portion of the model 110 that generates the deferral logit (while holding the classification logits fixed).

After performing the training 506, the system then uses the classification model 110 to classify new model inputs as described above.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a new model input;
processing the new model input using a classifier machine learning model to generate a model output that comprises:
(i) a respective classification probability for each of a plurality of classification categories, and
(ii) a respective misclassification probability that represents a likelihood that the new model input will be misclassified by an expert system that is different from the classifier machine learning model;
determining, from the model output, whether to defer the new model input for processing by the expert system, comprising:
obtaining a cost value that represents a cost associated with deferring model inputs to the expert system, and
determining whether to defer the new model input based on the cost value and the model output; and
in response to determining to defer the new model input:
providing the new model input for processing by the expert system;
obtaining, from the expert system, an expert classification output for the new model input; and
providing, as output, the expert classification output.

2. The method of claim 1, further comprising:
in response to determining not to defer the new model input:
determining a classification output from the respective classification probabilities for each of the plurality of classification categories, and
providing, as output, the classification output.

3. The method of claim 2, wherein determining a classification output from the respective classification probabilities for each of the plurality of classification categories comprising:
selecting a classification category that has a highest probability among the classification probabilities; and
generating a classification output that identifies the selected classification category.

4. The method of claim 1, wherein determining whether to defer the new model input based on the cost value and the model output comprises:
determining to defer the new model only when one minus the highest probability among the classification probabilities is greater than or equal to the sum of (i) the cost value and (ii) the misclassification probability.

5. The method of claim 1, wherein the classifier model is configured to generate:
(i) a respective classification logit score for each of the plurality of classification categories, and
(ii) a deferral logit score, and wherein processing the new model input using a classifier machine learning model to generate a model output comprises:
applying a softmax function to the classification logit scores to generate the respective classification probabilities, and
applying an inverse link function to the deferral logit score to generate the misclassification probability.

6. The method of claim 5, wherein the inverse link function is a sigmoid function.

7. The method of claim 1, further comprising:
training the classifier machine learning model on a training data set to minimize a loss function that measures a performance of classification outputs generated based on model outputs generated by the classifier machine learning model.

8. The method of claim 7, wherein the loss function assumes that the cost value is zero.

9. The method of claim 7, wherein the loss function is a hybrid loss function that estimates ground truth classification outputs using a cross-entropy loss and ground truth expert misclassification probabilities using a learning to defer loss.

10. The method of claim 9, wherein the learning to defer loss is a one-versus-all (OvA) loss.

11. A method performed by one or more computers and for training a classifier machine learning model, wherein the classifier machine learning model is configured to receive as input a model input and to process the model input to generate a model output that comprises:
(i) a respective classification logit score for each of a plurality of classification categories, and
(ii) a deferral logit score, the method comprising:
training the classifier machine learning model on a first training data set to minimize a loss function that measures a performance of a system that determines, using at least the deferral logit scores, whether to generate classification outputs based on model outputs generated by the classifier machine learning model or based on expert classification outputs generated by an expert system; and
after training the classifier machine learning model on the first training data set, training the classifier machine learning model on a second training data set to minimize a surrogate rejector loss that, for any given model input, measures an expected loss incurred by deferring the given model input for processing by the expert system given a) whether the given model input is misclassified by the classifier machine learning model and the expert system and b) a cost value that represents a cost associated with deferring model inputs to the expert system.

12. The method of claim 11, further comprising:
after training the classifier machine learning model on the second training data set,
obtaining a new model input;
processing the new model input using the classifier machine learning model to generate a new model output;
determining, from the new model output, whether to defer the new model input for processing by the expert system; and
in response to determining to defer the new model input:
providing the new model input for processing by the expert system;
obtaining, from the expert system, an expert classification output for the new model input; and
providing, as output, the expert classification output.

13. The method of claim 12, further comprising:
in response to determining not to defer the new model input:
determining a classification output from the respective classification logits for each of the plurality of classification categories in the new model output, and
providing, as output, the classification output.

14. The method of claim 13, wherein determining a classification output from the respective classification logits for each of the plurality of classification categories in the new model output comprises:
selecting a classification category having a largest classification logit from among the respective classification logits in the new model output.

15. The method of claim 12, wherein determining, from the new model output, whether to defer the new model input for processing by the expert system comprises:
determining not to defer the new model input only when a largest classification logit in the new model output is larger than the deferral logit in the new model output.

16. The method of claim 11, wherein the classifier machine learning model is configured to: process the model input to generate a shared embedding of the model input; for each classification category, apply a respective set of logit weights for the classification category to the shared embedding to generate the classification logit for the classification category, and apply a set of deferral logit weights to the shared embedding to generate the deferral logit.

17. The method of claim 16, wherein training the classifier on the second training data set comprises training the deferral logit weights while holding the classification logit weights for the classification categories fixed.

18. The method of claim 11, wherein the surrogate rejector loss, for any given model input, (i) is based on an output of a rejector function that is applied to a given model output for the given model input and that defines whether the given model input will be deferred to the expert system for processing and (ii) includes a) a first term that is based on a non-deferral confidence score for the given model input derived from the output of the rejector function and on whether the given model input is misclassified by the given model output and b) a second term that is based on a deferral confidence score for the given model input derived from the output of the rejector function and a cost value that represents a cost associated with deferring model inputs to the expert system.

19. The method of claim 18, wherein the rejector function measures a difference between a largest classification logit in the given model output and the deferral logit in the given model output.

20. The method of claim 18, wherein the rejector function is based on an input-dependent bias term and probabilities determined from the classification logits in the given model output, the deferral logit in the given model output, or both.

21. The method of claim 18, wherein the deferral confidence score is generated by applying a proper composite loss to a negative of the output of the rejector function.

22. The method of claim 18, wherein the non-deferral confidence score is generated by applying a proper composite loss to the output of the rejector function.

23. A system comprising:
one or more computers; and
one or more storage devices communicatively coupled to the one or more computers, wherein the one or more storage devices store instructions that, when executed by the one or more computers, cause the one or more computers to perform operations comprising:
obtaining a new model input;
processing the new model input using a classifier machine learning model to generate a model output that comprises:
(i) a respective classification probability for each of a plurality of classification categories, and
(ii) a respective misclassification probability that represents a likelihood that the new model input will be misclassified by an expert system that is different from the classifier machine learning model;
determining, from the model output, whether to defer the new model input for processing by the expert system, comprising:
obtaining a cost value that represents a cost associated with deferring model inputs to the expert system, and
determining whether to defer the new model input based on the cost value and the model output; and
in response to determining to defer the new model input:
providing the new model input for processing by the expert system;
obtaining, from the expert system, an expert classification output for the new model input; and
providing, as output, the expert classification output.
